(19) United States
(12) Patent Application Publication
(10) Pub. No.: US 2006/0194097 A1
(43) Pub. Date: Aug. 31, 2006

(54) Nano-structured metal-carbon composite for electrode catalyst of fuel cell and process for preparation thereof

(75) Inventors: Hee Jung Kim, Seoul (KR); Seong IHL Woo, Seoul (KR)

Correspondence Address: MERCHANT & GOULD PC, P.O. BOX 2903, MINNEAPOLIS, MN, 55402-0903, US

(73) Assignees: Kyungwon Enterprise Co., Ltd., Seoul (KR); Korea Advanced Institute of Science and Technology, Daejeon (KR)

(21) Appl. No.: 10/562,041

(22) PCT Filed: Jul. 16, 2003
(86) PCT No.: PCT/KR03/01407

§ 371 Date: Dec. 23, 2005

(51) Int. Cl. H01M 4/96; H01M 4/90; H01M 4/92; H01M 4/88; B01J 21/18; B01J 23/40

(52) U.S. Cl. 429/44; 502/101; 502/182; 502/185

(57) ABSTRACT

The present invention relates to a nano-structured metal-carbon composite and applications thereof, and more specifically, to a nano-structured metal-carbon composite obtained by consecutively impregnating a transition metal precursor and a carbon precursor in a nano frame and reacting the precursors at high temperature. In the metal-carbon composite of the present invention, metal is orderly polydispersed with less than 1 nanometer within a mesoporous carbon, and metal is chemically combined with carbon. Therefore, the metal-carbon composite is useful for electrocatalyst of fuel cells.

### TECHNICAL FIELD

The present invention generally relates to a nano-structured metal-carbon composite for an electrode catalyst of a fuel cell and a process for preparation thereof, and more specifically, to a nano-structured metal-carbon composite having an excellent electrochemical catalyst characteristic as an electrode material of a fuel cell and a process for preparing a metal-carbon composite obtained by successively impregnating a metal precursor and a carbon precursor in a nano template and reacting them.

### BACKGROUND ART

A fuel cell, which is a generator for directly converting chemical energy of fuel into electrical energy by means of electrochemical reaction, is advantageous because the fuel cell has higher electricity generating efficiency than any other generators such as a diesel generator and a vapor turbine generator and causes few problems due to harmful exhaust gas. The usage of such fuel cell is a solution to actively cope with international environmental regulations such as Convention on Climatic Change, and the fuel cell is expected as a substitute source of energy in countries whose resources are not abundant such as in Korea.

Generally, a catalyst impregnated in amorphous carbon with Pt or with an alloy having Pt as a main element has been widely used as an electrode material for fuel cell. However, as the amount of a metal impregnated in the electrode material becomes more increased, the size of metal crystal also becomes larger.

Meanwhile, in order to improve applicability of precious metals such as platinum, carbon having a larger specific surface area is fabricated, and then various metals are introduced into the carbon. For example, when platinum is impregnated in mesoporous carbon obtained using a silica nano template, the mesoporous carbon has a high specific surface area of 1000 m²/g. As a result, the platinum has a remarkably smaller crystal size in the mesoporous carbon than in commercial Vulcan-XC carbon. However, it is impossible to impregnate platinum in a micro-pore of not more than 1 nano-meter which is included in the mesoporous carbon through a conventional method. Moreover, such micro-pores deteriorate a surface transmission characteristic of hydrogen cations. Additionally, the thickness of the electrode becomes thicker to increase internal resistance.

### DETAILED DESCRIPTION OF THE INVENTION

In the present invention, there is provided a metal-carbon composite for an electrode catalyst of a fuel cell where metal is chemically bonded with carbon in a nano-structured mesoporous carbon.

In the present invention, a process for preparing a nano-structured metal-carbon composite for an electrode catalyst of a fuel cell comprises the steps of:

(a) preparing a nano template;

(b) adding the nano template in metal precursor solution to impregnate a metal in the nano template and dehydrate the nono template;

(c) adding the nano template impregnated with the metal in carbon precursor solution and mixing them uniformly;

(d) reacting the resultant mixture at high temperature;

(e) carbonizing the resultant reacted mixture; and

(f) removing the nano template from the resultant carbonized mixture.

In the process according to the present invention, material of the nano template in the step (a) is selected from silica oxide, alumina oxide or mixtures thereof, and preferably, is a silica oxide.

The step (a) includes a step of manufacturing and calcining a nano template.

In the nano-structured metal-carbon composite of the present invention, metal included in the metal-carbon composite is not specifically limited, and the metal is selected from the group consisting of Pt, Ru, Cu, Ni, Mn, Co, W, Fe, Ir, Rh, Ag, Au, Os, Cr, Mo, V, Pd, Ti, Zr, Zn, B, Al, Ga, Sn, Pb, Sb, Se, Te, Cs, Rb, Mg, Sr, Ce, Pr, Nd, Sm, Re and mixtures thereof. Further, the metal precursor is selected from (NH₃)₄Pt(NO₃)₂, (NH₃)₆RuCl₃, CuCl₂, Ni(NO₃)₂, MnCl₂, CoCl₂, (NH₄)₆W₁₂O₃₉, FeCl₂, (NH₄)₃IrCl₆, (NH₄)₃RhCl₆, AgCl, NH₄AuCl₄, NH₄OsCl₆, CrCl₂, MoCl₅, VCl₃, Pd(NO₃)₂, TiCl₄, ZrCl₄, ZnCl₂, BCl₃, AlCl₃, Ga₂Cl₄, SnCl₄, PbCl₂, SbCl₃, SeCl₄, TeCl₄, CsCl, RbCl, MgCl₂, SrCl₂, CeCl₃, PrCl₃, NdCl₃, SmCl₃, and ReCl₃.

Here, the metal-carbon composite comprises a single metal, or two or more metals of them. When the metal-carbon composite comprises two or more metals, the metals may be impregnated as a type of alloys or as a separately mixed type of them, by adjusting reaction conditions. For example, platinum and ruthenium separately or Pt—Ru alloy can be impregnated in a nano template using (NH₃)₄Pt(NO₃)₂ and (NH₃)₆RuCl₃ as precursor of platinum and ruthenium, respectively.

As described above, a single one or composite of two or more of the above metals can be impregnated, and the composite of two or more metals comprises preferably platinum.

The impregnation step is a process to induce the metal precursor to be penetrated into the nano template by impregnating the nano template in a metal precursor solution for a predetermined time and vacuum-dehydrating the resultant mixture.

In the step (c), a carbon precursor is added to the nano template impregnated with the metal precursor, and mixed uniformly. Here, the carbon precursor is selected from the group consisting of furfuryl alcohol, glucose and sucrose. More preferably, sucrose is used to obtain an excellent carbon nano array.

In addition to compounds described above, the carbon precursor is selected from the group consisting of a alcohol compound including a phenyl ring such as phenol, a polar compound including an olefin group such as acrylonitrile, and an alpha olefin compound such as propylene.

In the steps (d) and (e), the metal impregnated in the nano template and the carbon precursor are reacted, and carbonized through vacuum-heating successively to obtain a novel composite having a bond of metal of not more than 1 nano-meter with carbon.

Here, the step (d) is performed at a temperature ranging from 60 to 350° C., and the step (e) is performed under vacuum atmosphere at a temperature ranging from 800 to 1000° C.

In the step (f), the nano template is removed from the resultant carbonized mixture by using HF aqueous solution, and then washed to obtain a nano-structured metal-carbon composite according to the present invention.

In the metal-carbon composite fabricated by the above-described process, the metal is contained in an amount ranging from 1 to 95 wt % and the carbon is contained in an amount ranging from 5 to 99 wt %, based on the gross weight of the metal-carbon composite. More preferably, the metal is contained in an amount ranging from 4 to 36 wt % and the carbon is contained in an amount ranging from 64 to 96 wt %, based on the gross weight of the metal-carbon composite.

When the metal used in the metal-carbon composite of the present invention includes platinum as a first element and other metals as a second element, the second element metal is selected from the group consisting of Ru, Cu, Ni, Mn, Co, W, Fe, Ir, Rh, Ag, Au, Os, Cr, Mo, V, Pd, Ti, Zr, Zn, B, Al, Ga, Sn, Pb, Sb, Se, Te, Cs, Rb, Mg, Sr, Ce, Pr, Nd, Sm, Re and mixtures thereof. Here, it is preferable that the atom ratio of the second element metal: Pt is 4:96˜75:25. When the metal-carbon composite comprises two or more metals in the atom ratio above-described, it is confirmed that the characteristic of the metal-carbon composite as a fuel cell catalyst becomes more excellent.

In the present invention, a carbon precursor and a metal precursor are simultaneously introduced into a nano template and thermally treated under a high temperature vacuum atmosphere, thereby the carbon precursor is carbonized and the metal is reduced. As a result, the metal of not more than 1 nano-meter may be easily located in a micropore, and the metal and the carbon may form a covalent bond chemically so that a spill-over characteristic of adsorbed hydrogen can be induced. Since the spill-over characteristic of hydrogen is highly important to increase an electrode reaction rate of a fuel cell, the use of the metal-carbon composite of the present invention can improve the electrode reaction rate of a fuel cell.

Additionally, the metal-carbon composite according to an embodiment of the present invention may comprises chemical bonds of various metals with carbon. Moreover, when the composite is fabricated with precursors of two or more metals including platinum, an alloy or a metal mixture having various characteristics can be obtained. As a result, an alloy-carbon composite or a metal mixture-carbon composite can be fabricated which decreases the amount of platinum and increases the electrode catalyst activity of a fuel cell.

The above-described metal-carbon composite of the present invention can be utilized for an electrode of a fuel cell, specifically for a cathode catalyst. The feature that the metal-carbon composite of the present invention exhibits the excellent catalyst activity in the electrode reaction of a fuel cell may be confirmed in embodiments described later.

Although the metal-carbon composite of the present invention may be used as an electrode catalyst of any fuel cells which use hydrogen or hydrocarbon as a fuel, particularly it is useful for a cathode catalyst of a Direct Methanol Fuel Cell(DMFC).

One of main factors that degrade performance of the Direct Methanol Fuel Cell is a methanol cross-over where methanol penetrates into an electrolyte to cause a depolarization phenomenon in a cathode. Therefore, an electrode material of the cathode is required to have an excellent reduction reaction characteristic of oxygen and a little oxidation reaction characteristic to methanol. Here, it is confirmed that the above-described characteristics are remarkably improved in the metal-carbon composite of the present invention more than in any conventional electrode catalysts.

### BRIEF DESCRIPTION OF THE DRAWINGS

FIG. 1 is a TEM observation result of a nano-structured metal-carbon composite obtained from Example 2.

FIG. 2 is a XRD analysis result of a nano-structured metal-carbon composite obtained from Example 2.

FIG. 3 is a pore structure analysis result of a nano-structured metal-carbon composite obtained from Example 2.

FIG. 4 is an EXAFS analysis result of a nano-structured metal-carbon composite obtained from Example 2.

FIG. 5 is an oxygen reduction reaction characteristic result of a nano-structured platinum-carbon composite obtained from Example 3.

FIG. 6 is an oxygen reduction reaction characteristic result of a commercial fuel cell catalyst (Electrochem Co., Ltd. 20 wt % Pt/C).

FIG. 7 is a performance comparison and evaluation result (2M methanol fuel used) of a Direct Methanol Fuel Cell of an electrode-electrolyte joint using a nano-structured platinum-carbon composite obtained from Example 2 and a commercial fuel cell catalyst (Electrochem Co., Ltd. 20 wt % Pt/C).

FIG. 8 is a performance comparison and evaluation result (4M methanol fuel used) of a Direct Methanol Fuel Cell of an electrode-electrolyte joint using a nano-structured platinum-carbon composite obtained from Example 2 and a commercial fuel cell catalyst (Electrochem Co., Ltd. 20 wt % Pt/C).

### PREFERRED EMBODIMENTS

### EXAMPLE 1

A. Preparation of Nano Template (SBA-15)

Pre-heated 1.6M hydrochloric acid solution (380 mL) and surfactant Pluronic P123 (10 g) made by BASF Co., Ltd. were stirred and mixed at room temperature. Next, tetraethylorthosilicate (abbreviated as “TEOS”) (22 g) was added to the resultant mixture and stirred. Thereafter, TEOS was polymerized at 80° C. and the surfactant was removed, thereby obtaining SBA-15 as a nano template.

B. Preparation of Nano-Structured Pt—C Composite Using Nano Template

After the nano template (SBA-15) obtained from the preparation method A was calcined at 300° C., a Pt precursor solution was added to the nano template so that 30 wt % Pt based on the 1 g of the nano template was impregnated. The resultant mixture was dehydrated with a vacuum drier to impregnate Pt in the nano template. Here, (NH₃)₄Pt(NO₃)₂ was used as a Pt precursor. In the impregnation process, Pt precursor was induced to be introduced uniformly into the nano template by adding the nano template to Pt precursor solution and vacuum-drying the nano template. Thereafter, sucrose (0.7 g), sulphuric acid (0.08 g) and water (5 g) were added to the nano template impregnated with Pt and mixed uniformly. Here, the sulphuric acid serves as a catalyst for connecting lengthily, that is, polymerizing a carbon precursor, and the water serves as a medium for enabling the carbon precursor to penetrate into the nano template. Then, the resultant mixture was reacted at 100° C. and 160° C. respectively for 6 hours, and carbonized under a vacuum atmosphere at 900° C. The nano template was melt and removed with diluted fluoric acid aqueous solution, and washed, thereby obtaining a nano-structured Pt—C composite of the present invention (Pt: C=32 wt %: 68 wt %).

### EXAMPLE 2

A. Preparation of Nano Template (SBA-15)

The same procedure of Example 1 was repeated to obtain a nano template.

B. Preparation of Nano-Structured Pt—C Composite Using Nano Template

The same procedure of Example 1 was repeated except that 18 wt % Pt based on the 1 g of the nano template was impregnated, thereby obtaining a Pt—C composite of the present invention (Pt: C=24 wt %: 76 wt %).

### EXAMPLE 3

A. Preparation of Nano Template (SBA-15)

The same procedure of Example 1 was repeated to obtain a nano template.

B. Preparation of Nano-Structured Pt—C Composite Using Nano Template

The same procedure of Example 1 was repeated except that 6 wt % Pt based on the 1 g of the nano template was impregnated, thereby obtaining a Pt—C composite of the present invention (Pt: C=12 wt %: 88 wt %).

### EXAMPLE 4

A. Preparation of Nano Template (SBA-15)

The same procedure of Example 1 was repeated to obtain a nano template.

B. Preparation of Nano-Structured Pt—C Composite Using Nano Template

The same procedure of Example 1 was repeated except in that 3 wt % Pt based on the 1 g of the nano template was impregnated, thereby obtaining a Pt—C composite of the present invention (Pt: C=6 wt %: 94 wt %).

### EXAMPLE 5

A. Preparation of Nano Template (SBA-15)

The same procedure of Example 1 was repeated to obtain a nano template.

B. Preparation of Nano-Structured Pt—Ru—C Composite Using Nano Template

After the nano template (SBA-15) obtained from the preparation method A was calcined at 300° C., a Pt precursor solution and Ru precursor solution were added to the nano template so that 18 wt % Pt and Ru based on the 1 g of the nano template were impregnated. The resultant mixture was dehydrated with a vacuum drier to impregnate Pt and Ru in the nano template. Here, (NH₃)₄Pt(NO₃)₂ was used as a Pt precursor, (NH₃)₆RuCl₃ was used as a Ru precursor, and the atom ratio of Ru:Pt is 1:4.3. Thereafter, sucrose (2.5 g), sulphuric acid (0.28 g) and water (10 g) were added to the nano template and mixed uniformly. Then, the resultant mixture was reacted at 100° C. and 160° C. respectively for 6 hours, and carbonized under a vacuum atmosphere at 900° C. The nano template was melt and removed with diluted fluoric acid aqueous solution, and washed, thereby obtaining a nano-structured Pt—Ru—Carbon composite of the present invention (Pt—Ru: C=24 wt % : 76 wt %).

### EXAMPLE 6˜75

A. Preparation of Nano Template (SBA-15)

The same procedure of Example 1 was repeated to obtain a nano template.

B. Preparation of Nano-Structured Metal-Carbon Composite Using Nano Template

The same procedure of Example 5 was repeated except that kinds, content and atom ratios of metals were altered, thereby obtaining a metal-carbon composite of the present invention. Table 1 shows kinds, content, atom ratios of metals used in Examples 6˜75.

TABLE 1

| | Metal | | | | |
|---|---|---|---|---|---|
| | content | | | | |
| | in metal- | | | | |
| | carbon | Metal | Atom | | Activity |
| Exam- | composite | consti- | ratio | Precursor | (A/g |
| ple | (wt %) | tution | (M*/Pt) | of M* | metal) |
| 1 | 32 | Pt | — | — | 39 |
| 2 | 24 | Pt | — | — | 45 |
| 3 | 12 | Pt | — | — | See |
| 4 | 6 | Pt | — | — | 54 |
| 5 | 24 | Pt:Ru | 4.3 | (NH₃)₆RuCl₃ | 31 |
| 6 | 24 | Pt:Ru | 0.9 | (NH₃)₆RuCl₃ | 24 |
| 7 | 24 | Pt:Cu | 4.1 | CuCl₂ | 45 |
| 8 | 24 | Pt:Cu | 1.1 | CuCl₂ | 45 |
| 9 | 24 | Pt:Ni | 3.8 | Ni(NO₃)₂ | 32 |
| 10 | 24 | Pt:Ni | 1.4 | Ni(NO₃)₂ | 21 |
| 11 | 24 | Pt:Mn | 3.8 | MnCl₂ | 21 |
| 12 | 24 | Pt:Mn | 0.9 | MnCl₂ | 11 |
| 13 | 24 | Pt:Co | 2.8 | CoCl₂ | 35 |
| 14 | 24 | Pt:Co | 1.1 | CoCl₂ | 21 |
| 15 | 24 | Pt:W | 5.1 | (NH₄)₆W₁₂O₃₉ | 35 |
| 16 | 24 | Pt:W | 1.3 | (NH₄)₆W₁₂O₃₉ | 22 |
| 17 | 24 | Pt:Fe | 5.2 | FeCl₂ | 41 |
| 18 | 24 | Pt:Fe | 0.8 | FeCl₂ | 25 |
| 19 | 24 | Pt:Ir | 4.3 | (NH₄)₃IrCl₆ | 35 |
| 20 | 24 | Pt:Ir | 0.9 | (NH₄)₃IrCl₆ | 22 |
| 21 | 24 | Pt:Rh | 4.1 | (NH₄)₃RhCl₆ | 39 |
| 22 | 24 | Pt:Rh | 1.1 | (NH₄)₃RhCl₆ | 22 |
| 23 | 24 | Pt:Ag | 4.1 | AgCl | 34 |
| 24 | 24 | Pt:Ag | 1.2 | AgCl | 31 |
| 25 | 24 | Pt:Au | 3.4 | NH₄AuCl₄ | 44 |
| 26 | 24 | Pt:Au | 2.1 | NH₄AuCl₄ | 12 |
| 27 | 24 | Pt:Os | 2.3 | NH₄OsCl₆ | 47 |
| 28 | 24 | Pt:Cr | 2.1 | CrCl₂ | 35 |
| 29 | 24 | Pt:Cr | 1.2 | CrCl₂ | 22 |
| 30 | 24 | Pt:Mo | 5.1 | MoCl₅ | 36 |
| 31 | 24 | Pt:Mo | 2.1 | MoCl₅ | 22 |
| 32 | 24 | Pt:V | 3.8 | VCl₃ | 38 |
| 33 | 24 | Pt:V | 2.1 | VCl₃ | 21 |
| 34 | 24 | Pt:Pd | 3.1 | Pd(NO₃)₂ | 42 |
| 35 | 24 | Pt:Pd | 2.1 | Pd(NO₃)₂ | 32 |
| 36 | 24 | Pt:Ti | 6.1 | TiCl₄ | 36 |
| 37 | 24 | Pt:Ti | 2.1 | TiCl₄ | 24 |
| 38 | 24 | Pt:Zr | 5.4 | ZrCl₄ | 39 |
| 39 | 24 | Pt:Zr | 1.1 | ZrCl₄ | 24 |
| 40 | 24 | Pt:Zn | 4.6 | ZnCl₂ | 38 |
| 41 | 24 | Pt:Zn | 0.9 | ZnCl₂ | 26 |
| 42 | 24 | Pt:B | 3.1 | BCl₃ | 31 |
| 43 | 24 | Pt:B | 2.1 | BCl₃ | 11 |
| 44 | 24 | Pt:Al | 3.8 | AlCl₃ | 26 |
| 45 | 24 | Pt:Al | 1.0 | AlCl₃ | 11 |
| 46 | 24 | Pt:Ga | 6.5 | Ga₂Cl₄ | 31 |
| 47 | 24 | Pt:Ga | 1.6 | Ga₂Cl₄ | 21 |
| 48 | 24 | Pt:Sn | 3.5 | SnCl₄ | 35 |
| 49 | 24 | Pt:Sn | 1.2 | SnCl₄ | 22 |
| 50 | 24 | Pt:Pb | 3.9 | PbCl₂ | 32 |
| 51 | 24 | Pt:Pb | 1.1 | PbCl₂ | 11 |
| 52 | 24 | Pt:Sb | 3.5 | SbCl₃ | 32 |
| 53 | 24 | Pt:Sb | 1.9 | SbCl₃ | 15 |
| 54 | 24 | Pt:Se | 5.1 | SeCl₄ | 37 |
| 55 | 24 | Pt:Se | 1.2 | SeCl₄ | 18 |
| 56 | 24 | Pt:Te | 6.1 | TeCl₄ | 34 |
| 57 | 24 | Pt:Te | 2.1 | TeCl₄ | 19 |
| 58 | 24 | Pt:Ce | 6.4 | CeCl₃ | 45 |
| 59 | 24 | Pt:Ce | 1.2 | CeCl₃ | 19 |
| 60 | 24 | Pt:Rb | 3.7 | RbCl | 38 |
| 61 | 24 | Pt:Rb | 0.9 | RbCl | 22 |
| 62 | 24 | Pt:Mg | 5.5 | MgCl₂ | 41 |
| 63 | 24 | Pt:Mg | 2.1 | MgCl₂ | 22 |
| 64 | 24 | Pt:Sr | 4.1 | SrCl₂ | 24 |
| 65 | 24 | Pt:Sr | 2.1 | SrCl₂ | 15 |
| 66 | 24 | Pt:Cs | 3.8 | CsCl | 42 |
| 67 | 24 | Pt:Cs | 1.1 | CsCl | 24 |
| 68 | 24 | Pt:Pr | 4.7 | PrCl₃ | 45 |
| 69 | 24 | Pt:Pr | 1.3 | PrCl₃ | 11 |
| 70 | 24 | Pt:Nd | 5.4 | NdCl₃ | 26 |
| 71 | 24 | Pt:Nd | 0.9 | NdCl₃ | 9 |
| 72 | 24 | Pt:Sm | 3.5 | SmCl₃ | 20 |
| 73 | 24 | Pt:Sm | 2.1 | SmCl₃ | 10 |
| 74 | 24 | Pt:Re | 6.1 | ReCl₃ | 46 |
| 75 | 24 | Pt:Re | 1.2 | ReCl₃ | 28 |

Pt Precursor Used: (NH₃)₄Pt(NO₃)₂
*M: second element metal used with Pt

The following analysis experiment was performed to find the structure of the nano-structured metal-carbon composite prepared using a nano template in the above Examples.

### EXPERIMENTAL EXAMPLE 1

### Structural Analysis

In order to analyze the structure of the nano-structured metal-carbon composite obtained from the above Examples, a Transmission Electron Microscope (abbreviated as “TEM”), a X-ray Diffractometer (abbreviated as “XRD”), a pore analyzer, an Extended X-ray Absorption Fine Structure (abbreviated as “EXAFS”) were used.

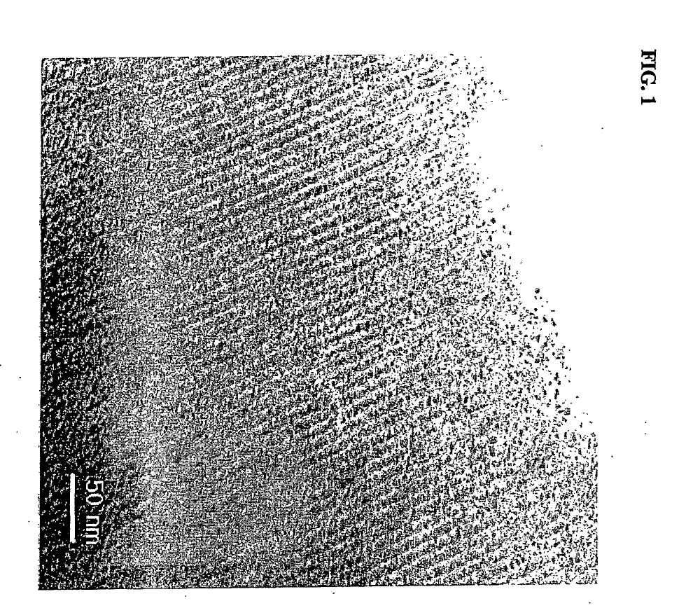

FIG. 1 is a TEM observation result of powder of a nano-structured platinum-carbon composite obtained from Example 2. As shown in FIG. 1, the disclosed nano-structured metal-carbon composite according to the present invention was observed to have a 3-dimensional structure.

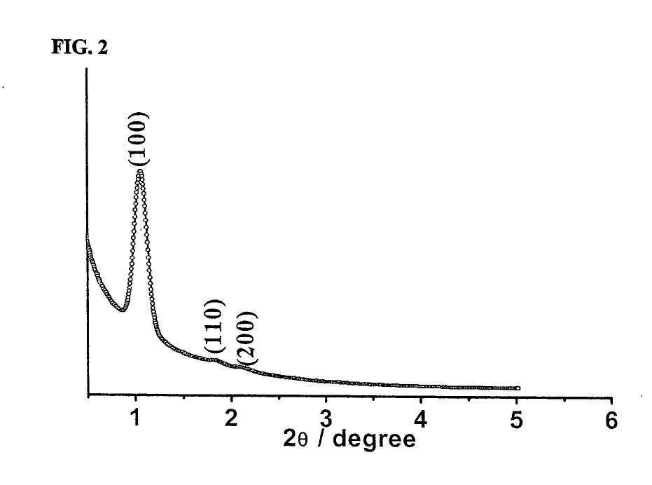

FIG. 2 is a XRD analysis result of a nano-structured platinum-carbon composite obtained from Example 2. Since the XRD analysis result of the disclosed nano-structured metal-carbon composite was the same as that of SBA-15, the disclosed composite was observed to have a replica fabricated as a shape of the nano template. This experimental result supports the fact that the nano-structured platinum-carbon composite has a 3-dimensional structure.

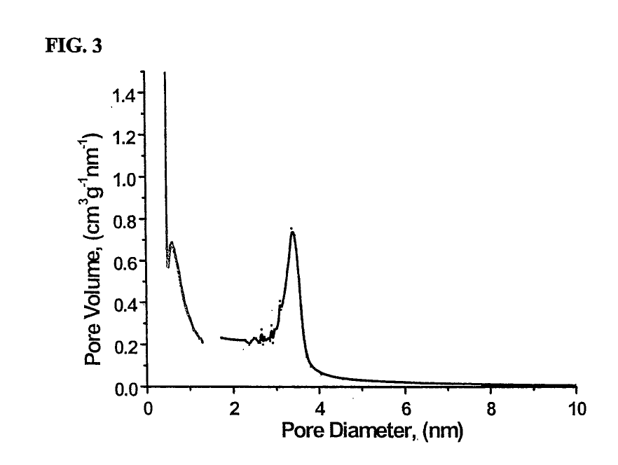

FIG. 3 is a pore structure analysis result of a nano-structured platinum-carbon composite obtained from Example 2. FIG. 3 shows that the disclosed composite has a great deal of fine pores consisting of micro-pores of not more than 1 nano-meter and mesopores. As a result of calculation with adsorption isotherm, the BET surface area is observed to be almost 1700 m²/g.

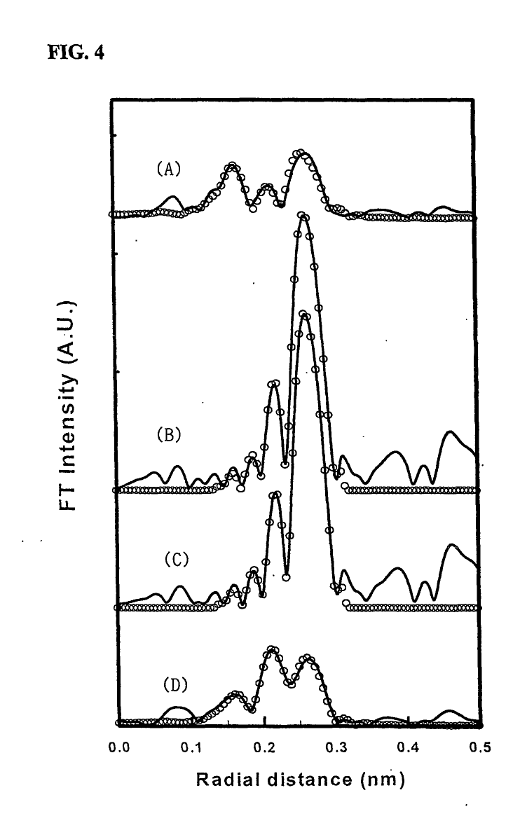

FIG. 4 is an EXAFS analysis results of a nano-structured platinum-carbon composite obtained from Example 2 and the conventional platinum-carbon composite. The curves (A) and (D) show a result of the disclosed platinum-carbon composite of the present invention, and the curves (B) and (C) show a result of the conventional composite.

More specifically, the curve (A) of FIG. 4 shows an analysis result of the platinum-carbon composite obtained from Example 2, and the curve (D) shows an analysis result of the platinum-carbon composite obtained from Example 2 which was subsequently treated with bromine mixed solution (Microporous and Mesoporous Mat. 31, 23-31 (1999)) so that platinum was present only in micro-pores of not more than 1 nano-meter.

Also, the curve (B) shows a result using a platinum-carbon composite obtained by dispersing commercial Vulcan carbon in dilute H₂PtCl₆ solution, dehydrating the resultant mixture with an evaporating drier and then reducing the resultant mixture under a hydrogen atmosphere at 310° C. Although the curve (C) has the same procedure as that of the curve (B), the curve (C) shows a result of a platinum-carbon composite using mesoporous carbon obtained by carbonizing only a carbon precursor in a nano template (J. Am. Chem. Soc. 122, 10712-10713 (2000)) instead of Vulcan carbon.

Table 2 shows a graph simulation result of EXAFS from the analysis result of FIG. 4.

TABLE 2
Graph simulation result of EXAFS

| | | | | Pt—Pt | Pt—C |
|---|---|---|---|---|---|
| | | Pt—Pt | Pt—C | bond | bond |
| | | bond | bond | length | length |
| | Sample | number | number | (nm) | (nm) |
| A | Pt—C | 4.31 | 2.73 | 0.2735 | 0.2041 |
| | Composite (1) | | | | |
| | of the present | | | | |
| | invention | | | | |
| B | Conventional | 9.58 | | 0.2757 | |
| | Pt/C (1) | | | | |
| C | Conventional | 9.71 | | 0.2757 | |
| | Pt/C (2) | | | | |
| D | Pt—C | 2.78 | 2.12 | 0.2736 | 0.2014 |
| | Composite (2) | | | | |
| | of the present | | | | |
| | invention | | | | |

As shown in Table 2, the Pt—C bond number and length could be determined in the nano-structured Pt—C composites of the present invention [corresponding to the curves (A) and (D) of the analysis result of FIG. 4] while the Pt—C bond number and length could not be determined in the conventional Pt/C composites [corresponding to the curves (B) and (C) of the analysis result of FIG. 4].

It is clear from the above results that metal and carbon are simply mixed in the conventional composites, while metal and carbon are not simply mixed but platinum of not more than 1 nano-meter and carbon are chemically bonded in the disclosed nano-structured Pt—C composite of the present invention. Furthermore, it is precisely known that the disclosed composite has a novel structure of chemical bond even in fine micro-pores of not more than 1 nano meter. Accordingly, the stable chemical bond of metal and carbon represents a novel characteristic structure of the disclosed nano-structured Pt—C composite.

From the above-described analysis results, the disclosed nano-structured Pt—C composite of the present invention has a 3-dimensional structure with a nano size, and Pt of not more than 1 nano meter in fine pores is chemically bonded with carbon regularly and 2 or 3-dimensionally, and multi-dispersed.

The experiment for confirming electrochemistry and electrode-electrolyte joint performance was performed to find a catalyst activity of a fuel cell of the nano-structured platinum-carbon composites obtained from Examples 1 to 75.

### EXPERIMENTAL EXAMPLE 2

### Half Cell Experiment

After the nano-structured Pt—C composite (4 mg) obtained from Example 3 as an electrode catalyst and 5% Nafion solution (80 μL) as a bonding agent were dispersed uniformly in water (4 mL), the dispersed solution (60 μL) was dropped onto a carbon substrate. Then, the resultant substrate was heated in an oven at 80° C. to prepare an electrode coated with an electrode catalyst. The current density was measured for various potential differences with repect to a reference electrode (Ag/AgCl) in various kinds of electrolytes.

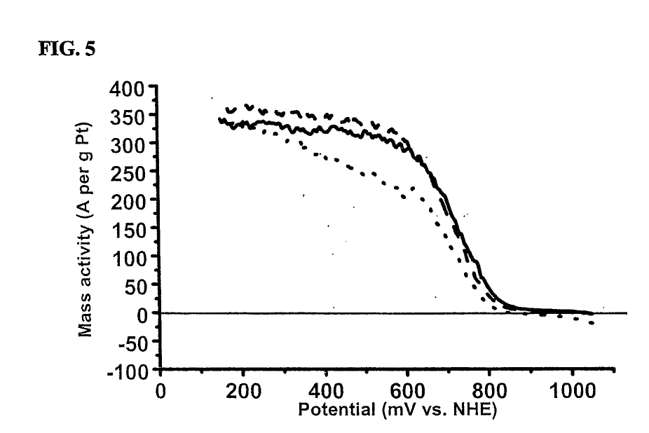

FIG. 5 shows a half cell experimental result on oxygen reduction reaction of the nano-structured platinum-carbon composite obtained from Example 3 depending on variation of methanol concentration. The solid line ( ______ ) of the graph represents the case where methanol is not included in 1M HClO₄ electrolyte, the broken line ( - - - ) and the dotted line ( . . . ) represents the cases where 0.5M and 2M methanol are included in electrolyte, respectively.

Meanwhile, the above-described half cell experiment was repeated on the metal-carbon composites obtained from Examples 1˜2 and 4˜75 as well as on the metal-carbon composite obtained from Example 3. As a result, the oxygen reduction reaction activity, that is, the Y-axis value at the X-axis value of 850 mV potential in FIG. 5 was shown in Table 1.

### COMPARATIVE EXPERIMENTAL EXAMPLE 1

### Half Cell Experiment

The same procedure of Example 2 was repeated except that commercial 20 wt % Pt/C (Electrochem Co., Ltd) was used instead of the disclosed Pt—C composite.

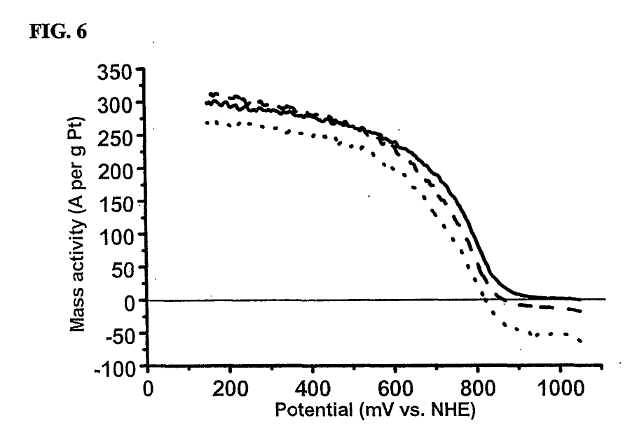

FIG. 6 is a graph illustrating a half cell experimental result on oxygen reduction reaction of the commercial platinum-carbon composite obtained from the above procedure depending on variation of methanol concentration. The solid line ( ______ ) of the graph represents the case where methanol is not included in 1M HClO₄ electrolyte, the broken line ( - - - ) and the dotted line ( . . . ) represents the cases where 0.5M methanol and 2M methanol are included in electrolyte, respectively.

As shown from the half cell experimental results of FIGS. 5 and 6, it is understood that the disclosed Pt—C composite of the present invention has specific characteristics such as the excellent oxygen electric reduction reaction and the low activity on methanol.

### EXPERIMENTAL EXAMPLE 3

### Performance Experiment of Electrode-Electrolyte Joint

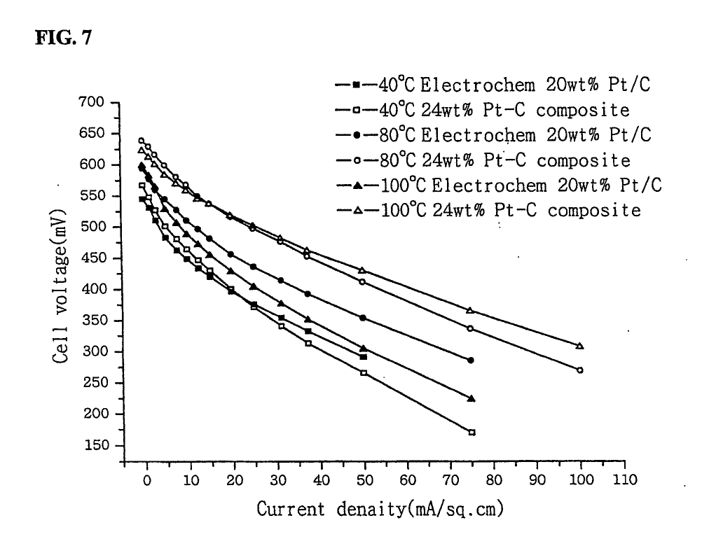

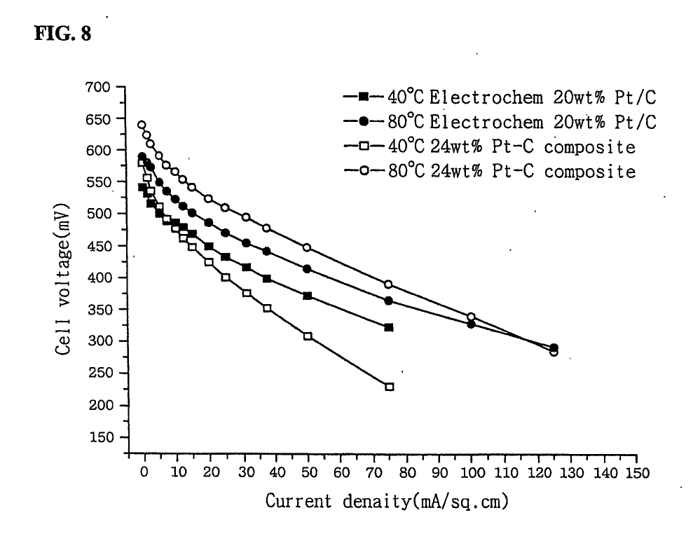

A gaseous diffusion layer using a carbon paper was coated with the catalyst obtained from Example 2 to prepare a cathode of a Direct Methanol Fuel Cell, a gaseous diffusion layer using a carbon paper was coated with commercial PtRu powder to prepare an anode, and an electrolyte-electrode joint (assembly) having a nafion electrolyte membrane (Nafion 117) as an ion exchange membrane was prepared. 15% of the nafion electrolyte (Nafion 117) was added to a catalyst coating layer of the anode, and 7% of the nafion electrolyte (Nafion 117) was added to a catalyst coating layer of the cathode. The anode and the cathode between which the nafion electrolyte membrane was interposed was thermally compressed at 120° C. for 2 minutes to prepare an assembly. FIGS. 7 and 8 show voltage-current result measured depending on temperatures of the prepared assembly. Here, the conditions of the anode are 5 mg PtRu/sq.cm, 2M or 4M methanol 2 ml/min and 0 psig, and the conditions of the cathode are 0.6 mg Pt/sq.cm, oxygen 500 ml/min and 0 psig, and the electrolyte used is Nafion 117.

### COMPARATIVE EXPERIMENTAL EXAMPLE 2

### Performance Experiment of Electrode-Electrolyte Joint

The same procedure of Example 3 was repeated except that using commercial 20 wt % Pt/C (Electrochem Co., Ltd.) was used instead of the disclosed Pt—C composite. The experimental results were shown in FIGS. 7 and 8.

FIG. 7 shows an experimental result of a Direct Methanol Fuel Cell of an electrode-electrolyte joint when 2M methanol was used as a fuel, and FIG. 8 shows an experimental result of a Direct Methanol Fuel Cell of an electrode-electrolyte joint when 4M methanol was used as a fuel. In other words, FIGS. 7 and 8 show performance curves of electrode-electrolyte joints using 2M methanol and 4M methanol as anode fuels, respectively, and oxygen as cathode fuels.

As shown from the performance results of FIGS. 7 and 8, it is understood that the electrode-electrolyte joint using the disclosed Pt—C composite of the present invention has the excellent performance and high open circuit voltages at all reaction temperatures, especially at high temperature.

### INDUSTRIAL APPLICABILITY

As described above, the nano-structured metal-carbon composite and the process for preparation thereof according to the present invention make the preparation process of metal-carbon composite simpler and more economical than the conventional process for preparing a metal-carbon composite, and also improve the performance of fuel cells. Accordingly, the composite and the process according to the present invention are applied to a fuel cell for generating electricity with hydrogen and hydrocarbon which are clean energy, thereby providing a remarkable solution on exhaustion of energy resources and pollution due to usage of fossil fuel on which extensive studies have been currently made.

In addition, the nano-structured metal-carbon composite and the process for preparation thereof are more economical since the composite can be prepared without additionally changing apparatus by impregnating both a metal precursor and a carbon precursor in a nano template.

1. A nano-structured metal-carbon composite for an electrode catalyst of a fuel cell, wherein metal is impregnated in mesoporous carbon through a chemical bond with carbon.

2. The nano-structured metal-carbon composite according to claim 1, wherein the metal is multi-dispersed regularly and 2 or 3-dimensionally in the mesoporous carbon at an interval of not more than 1 nanometer.

3. The nano-structured metal-carbon composite according to claim 1, wherein the metal is selected from the group consisting of Pt, Ru, Cu, Ni, Mn, Co, W, Fe, Ir, Rh, Ag, Au, Os, Cr, Mo, V, Pd, Ti, Zr, Zn, B, Al, Ga, Sn, Pb, Sb, Se, Te, Cs, Rb, Mg, Sr, Ce, Pr, Nd, Sm, Re and mixtures thereof.

4. The nano-structured metal-carbon composite according to claim 1, wherein the metal is contained in an amount ranging from 1 to 95 wt % and the carbon is contained in an amount ranging from 5 to 99 wt %, based on the gross weight of the metal-carbon composite.

5. The nano-structured metal-carbon composite according to claim 4, wherein the metal is contained in an amount ranging from 4 to 36 wt % and the carbon is contained in an amount ranging from 64 to 96 wt %, based on the gross weight of the metal-carbon composite.

6. The nano-structured metal-carbon composite according to claim 1, wherein the metal is pure Pt.

7. The nano-structured metal-carbon composite according to claim 1, wherein the metal is an alloy or a mixture of a first metal and a second metal, and the first metal is platinum.

8. The nano-structured metal-carbon composite according to claim 7, wherein the second metal is selected from the group consisting of Ru, Cu, Ni, Mn, Co, W, Fe, Ir, Rh, Ag, Au, Os, Cr, Mo, V, Pd, Ti, Zr, Zn, B, Al, Ga, Sn, Pb, Sb, Se, Te, Cs, Rb, Mg, Sr, Ce, Pr, Nd, Sm, Re, mixtures or alloys thereof.

9. The nano-structured metal-carbon composite according to claim 7, wherein the atom ratio of the second metal: the first metal is 4:96˜75:25.

10. A fuel cell wherein an electrode coated with a catalyst including a nano-structured metal-carbon composite, wherein metal is impregnated in a mesoporus carbon through a chemical bond with carbon, is adopted as a cathode.

11. The fuel cell according to claim 10, wherein the fuel cell uses hydrogen or hydrocarbon as a fuel.

12. The fuel cell according to claim 10, wherein the fuel cell is a Direct Methanol Fuel Cell.

13. The fuel cell according to claim 10, wherein a cathode includes a substrate which is a gaseous diffusion layer using a carbon paper, and the electrode catalyst,
an anode includes a substrate which is a gaseous diffusion layer using a carbon paper, and an alloy catalyst whose main element is platinum as an electrode catalyst, and
an ion exchange membrane is cationic conductive electrolyte.

14. A process for preparing a nano-structured metal-carbon composite for an electrode catalyst of a fuel cell, comprising the steps of:
(a) preparing a nano template;
(b) adding the nano template in metal precursor solution to impregnate a metal in the nano template and dehydrate the nano template;
(c) adding the nano template impregnated with the metal in carbon precursor solution and mixing them uniformly;
(d) reacting the resultant mixture at high temperature;
(e) carbonizing the resultant reacted mixture; and
(f) removing the nano template from the resultant carbonized mixture.

15. The process according to claim 14, wherein the nano template is selected from silica, alumina or mixtures thereof.

16. The process according to claim 15, wherein the nano template is a silica type.

17. The process according to claim 14, wherein the step (d) is performed at a temperature ranging from 60 to 350° C., and the step (e) is performed at a temperature ranging from 800 to 1000° C.

18. The process according to claim 14, wherein the carbon precursor is selected from the group consisting of furfuryl alcohol, glucose and sucrose.

19. The process according to claim 18, wherein the carbon precursor is sucrose.

20. The process according to claim 14, wherein the carbon precursor is selected from the group consisting of a alcohol compound including a phenyl ring, a polar compound including an olefin group and an alpha olefin compound.

21. The process according to claim 20, wherein the carbon precursor is selected from the group consisting of phenol, acrylonitrile and propylene.

22. A nano-structured metal-carbon composite for an electrode catalyst of a fuel cell, fabricated by the process described in claim 14.
